(19) United States
(12) Patent Application Publication
(10) Pub. No.: US 2003/0226210 A1
(43) Pub. Date: Dec. 11, 2003

(54) Cleaning and rinsing of textile fabrics

(75) Inventors: Fakhruddin Esmail Pacha, Mumbai (IN); Steven Paul Rannard, Wrral Merseyside (GB)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/214,853

(22) Filed: Aug. 8, 2002

(30) Foreign Application Priority Data
Jun. 5, 2002 (EP) 02253892.0

(51) Int. Cl. C11D 1/00

(52) U.S. Cl. 8/115.51

(57) ABSTRACT

A method of washing and rinsing a textile fabric, the method comprising a washing step wherein the washing liquor comprises an anionic surfactant and a nonionic surfactant and a rinse additive encapsulated in a terpolymer.

### FIELD OF THE INVENTION

The present invention relates to the cleaning and rinsing of textile fabrics, wherein both wash and rinse compositions are placed in a wash liquor with the fabric, and then a rinsing step is carried out in a rinse liquor, whereby release of at least some of the rinse composition is delayed until the rinse.

### BACKGROUND OF THE INVENTION

U.S. Pat. No. 4,801,636 discloses a comminuted wash additive in a water soluble polymeric film envelope or in microcapsules of the water soluble polymer, or in a water-insoluble envelope sealed with the water soluble polymer. The water soluble polymer typically comprises polyvinyl alcohol and alkyl cellulose monomer units together with a cross-linking agent. The polymer is insoluble at higher pH but becomes increasingly soluble as the pH is reduced.

It is also known from U.S. Pat. No. 4,108,600 to coat fabric conditioner particles with a coating, the solubility of which is pH dependent. The coating comprises a water soluble polymer, preferably a polyvinyl alcohol or gelatin of defined molecular weight and isoelectric point.

JP 60/141,705 (Lion corporation) discloses a specific copolymer which is insoluble in alkaline water of pH of 9.5 or higher and soluble in water of pH of 8.5 and lower. This is achieved by using a terpolymer, whereby the ratio of monomers are in a specific range to assure that de desired solubility properties are observed in solutions of 250 ppm linear alkyl benzenesulfonic acid (high pH) and 15 ppm ppm linear alkylbenzenesulfonic acid (low pH).

A problem with the terpolymers as disclosed in this Japanese patent publication is that they are less suitable for use in combination with cleaning compositions comprising a mixture of surfactants in particular in combination with cleaning compositions comprising a combination of anionic and nonionic surfactants.

Surprisingly it has now been found that specific terpolymers can advantageously be used for delayed release into the rinse after the cleaning with a combination of anionic and nonionic surfactants.

### DEFINITION OF THE INVENTION

Thus, in a first aspect, the present invention provides a method of washing and rinsing a textile fabric, the method comprising:

(a) a washing step wherein the washing liquor comprises an anionic surfactant and a nonionic surfactant and a rinse additive encapsulated in a terpolymer; and

(b) subsequent to the washing step (a), a rinse step

wherein the terpolymer comprises monomers A, B and C, wherein:

A is a monomer represented by the fomula

CH₂═C(R³)—COOCH₂CH₂N (R¹) R²

Wherein R¹ and R²each are independantly chosen from alkyl groups having 1, 2 or 3 carbon atoms; and wherein R³ is a hydrogen or a methyl group; and

Wherein B is selected from the group of esters of a C1-3 alcohol with a member of the group of acrylic acid, methacrylic acid, crotonic acid, itaconic acid and vinyl acetate;

C is selected from the group of N,N dimethylaminopropyl(meth) acrylic acid amide, N,N dimethyl(meth)acrylic acid amide, 2-hydroxyethyl(meth)acrylate, 2-hydroxypropyl(meth)acrylate) or esters of (meth) acrylic acid and polyetheylene glycol or methoxypolyethylene glycol (p=2−50); and

Wherein A is present in amounts of 5-95 wt % of the terpolymer; B is present in amounts of less than 66 wt % of the terpolymer and C is present in levels of at least 1 wt % of the terpolymer; and wherein the level of B (B) in relation to the level of A (A) satisfies the following conditions:

(1) 0<B<66%−0.5*A

(2) 30%−0.5*A<B<66%.

In a second aspect of the present invention provides a composite washing product comprising

(I) a cleaning composition comprising an anionic and a nonionic surfactant; and

(II) a rinse additive encapsulated in a terpolymer;

wherein the terpolymer comprises monomers A, B and C, wherein:

A is a monomer represented by the fomula

CH₂═C(R³)—COOCH₂CH₂N (R¹)R²

Wherein R¹ and R² each are independantly chosen from alkyl groups having 1, 2 or 3 carbon atoms; and wherein R³ is a hydrogen or a methyl group; and

Wherein B is selected from the group of esters of a C1-3 alcohol with a member of the group of acrylic acid, methacrylic acid, crotonic acid, itaconic acid and vinyl acetate;

C is selected from the group of N,N dimethylaminopropyl(meth) acrylic acid amide, N,N dimethyl(meth)acrylic acid amide, 2-hydroxyethyl(meth)acrylate, 2-hydroxypropyl(meth)acrylate) or esters of (meth) acrylic acid and polyetheylene glycol or methoxypolyethylene glycol (p=2−50); and

Wherein A is present in amounts of 5-95 wt % of the terpolymer; B is present in amounts of less than 66 wt % of the terpolymer and C is present in levels of at least 1 wt % of the terpolymer; and wherein the level of B (B) in relation to the level of A (A) satisfies the following conditions:

(3) 0<B<66%−0.5*A

(4) 30%−0.5*A<B<66%.

Preferably the level of A is from 20-60 wt %, the level of B is preferably from 5-40 wt % or 80-94 wt % based on the weight of the terpolymer.

Preferably A is N, N-dimethylaminoethylmethacrylate

Preferably B is methyl methacrylate

Preferably C is dimethylaminopropylmethacrylic acid amine.

Advantageously it has also been found that the polymers as described above can have a positive contribution to the cleaning performance of the composite detergent product.

### DETAILED DESCRIPTION OF THE INVENTION

Composite washing products of the invention can take any suitable form. For example the cleaning composition can be a liquid, powder or unit dose form such as a sachet or tablet. Similarly the encapsulated rinse additive can take any suitable form e.g. sachet, capsule, coated particulates etc. The rinse additive can equally take any suitable form for example liquid, powder, tablet, plastic composition etc. The composite washing product may comprise the cleaning product and the rinse additive as separate entities, but more preferred the cleaning product and the rinse additive are combined in a single entity.

Examples of suitable single entity composite washing products are for example powdered cleaning composition wherein encapsulated rinse additives are present as small particles mixed with the powder; a powdered cleaning composition in a sachet, wherein the sachet also comprises an encapsulated rinse additive for example as one or more particles or a capsule; a liquid cleaning composition contained in a capsule wherein the capsule also comprises a second rinse additive capsule in accordance to the invention. An especially preferred embodiment of the invention relates to a cleaning tablet with a first region comprising the cleaning composition and a second region comprising the encapsulated rinse additive. It will be apparent to the skilled person that other combinations of cleaning compositions and encapsulated rinse additives can be formed. For ease of reference the invention will be described in more detail with reference to a tablet comprising a first cleaning region and a second rinse additive region.

Tablets can be made by several techniques e.g. extrusion, casting or compression. Tableting suitably may entail compaction of a particulate composition. A variety of tableting machinery is known, and can be used. Generally it will function by stamping a quantity of the particulate composition which is confined in a die. Tableting machinery able to carry out such operations is known. For example, suitable tablet presses are available from Fette and from Korsch.

The size of a tablet will suitably range from 10 to 160 grams (gm), preferably from 15 to 60 gm, depending on the conditions of intended use, and whether the tablet represents a dose for an average load in a fabric washing or a fractional part of such a dose. The tablets may be of any shape. However, for ease of packaging they are preferably blocks of substantially uniform cross-section, such as cylinders or cuboids. The overall density of a tablet is preferably 1040 or 1050 gm/litre, better 1100 gm/litre, up to 1300 or 1350 gm/litre or even more. The tablet density may well lie in a range up to no more than 1250 or even 1200 gm/litre.

Tablets in which the rinse composition is held in a separate region for example a central cavity (the body of the tablet) containing a wash composition may be formed using an appropriately shaped die or by delivering the rinse additive to the tablet after initial shaping.

The Rinse Composition

The rinse additive for use in accordance to the invention contains at least one agent which exerts a beneficial action upon a textile in the rinse. Suitable examples of such agents include fabric softening agents, especially cationic softening compounds, antistatic agents, ease of ironing agents, anti-wrinkling/crease protection agents, perfume and optical brighteners. Alternatively, delayed release by means of the invention is also beneficial for e.g. oxygen bleach, bleach activators, soil release agent, enzymes, suds supressors, disinfectants, anti-redeposition aids, dye transfer inhibitors.

If desired the rinse additive material may be in combination with a suitable carrier material. Rinse additives may suitably contain one or more formulation aids and/or dispersing aids. Preferably the weight ratio of cleaning composition to encapsulated rinse additive is from 50:1 to 1:5, more preferred from 10:1 to 1:1.

A discussion of materials which are known as fabric softening agents and which may be used in the tablets of the present invention is found in published International Patent Application WO 94/24999.

Examples of suitable rinse additive agents are:

(a) Cationic Fabric Softening Compounds

Suitable cationic fabric softening compounds may be selected from those typically included in rinse-added fabric softening compositions, for example cationic softening agents, clay, cellulases softeners, polysiloxanes.

It is especially preferred if the cationic softening agent is a water insoluble quaternary ammonium material which comprises a compound having two C₁₂₋₁₈ alkyl or alkenyl groups connected to the nitrogen head group via at least one ester link. It is more preferred if the quaternary ammonium material has two ester links.

A first preferred type of ester-linked quaternary ammonium material is represented by formula (I):

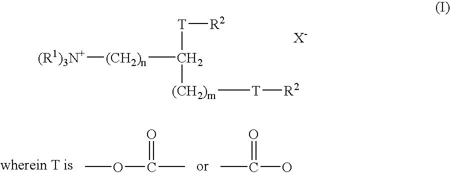

each R¹ group is independently selected from C₁₋₄, alkyl or hydroxyalkyl or C₂₋₄ alkenyl groups; and wherein each R² group is independently selected from C₈₋₂₈ alkyl or alkenyl groups; X⁻ is any suitable anion including a halide, acetate or lower alkosulphate ion, such as chloride or methosulphate, n is 0 or an integer from 1 to 5, and m is an integer from 1 to 5.

Preferred materials of this class such as 1,2 bis[hardened tallowoyloxy]-3-trimethylammonium propane chloride and their method of preparation are, for example, described in U.S. Pat. No. 4,137180 (Lever Brothers). Preferably these materials comprise small amounts of the corresponding monoester as described in U.S. Pat. No. 4,137,180 for example 1-hardened tallowoyloxy-2-hydroxy 3-trimethylammonium propane chloride.

A second type of ester-linked quaternary ammonium material is represented by the formula (II):

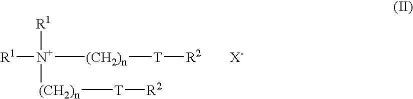

wherein T, R¹, R², n, and X⁻ are as defined above.

Especially preferred materials within this formula are dialkenyl esters of triethanol ammonium methyl sulphate and N-N-di(tallowoyloxy ethyl) N,N-dimethyl ammonium chloride. Commercial examples of compounds within this formula are Tetranyl® AOT-1 (di-oleic ester of triethanol ammonium methyl sulphate 80% active), AO-1(di-oleic ester of triethanol ammonium methyl sulphate 90% active), AHT-1 (di-hardened oleic ester of triethanol ammonium methyl sulphate 90% active), L1/90 (partially hardened tallow ester of triethanol ammonium methyl sulphate 90% active), L5/90 (palm ester of triethanol ammonium methyl sulphate 90% active (supplied by Kao corporation) and Rewoquat WE15 (C₁₀-C₂₀ and C₁₆-C₁₈ unsaturated fatty acid reaction products with triethanolamine dimethyl sulphate quaternised 90% active), ex Witco Corporation.

A third preferred type of quaternary ammonium material is represented by formula (III):

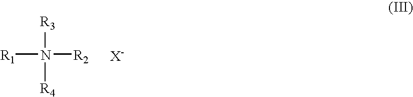

where R₁ and R₂ are C₈₋₂₈ alkyl or alkenyl groups; R₃ and R₄ are C₁₋₄ alkyl or C₂₋₄ alkenyl groups and X⁻ is as defined above.

Examples of compounds within this formula include di(tallow alkyl)dimethyl ammonium chloride, di(tallow alkyl) dimethyl ammonium methyl sulphate, dihexadecyl dimethyl ammonium chloride, di(hardened tallow alkyl) dimethyl ammonium chloride, dioctadecyl dimethyl ammonium chloride and di(coconut alkyl) dimethyl ammonium chloride.

It is advantageous for environmental reasons if the quaternary ammonium material is biologically degradable.

Co-active softening surfactants for cationic surfactants may also be incorporated in an amount from 0.01 to 20% by weight, more preferably 0.05 to 10%, based on the total weight of the rinse additive. Preferred co-active softening surfactants are fatty amines and fatty N-oxides.

b) Cellulases

British Patent Specification GB 1 368 599 (Unilever) discloses the use of cellulolytic enzymes, i.e. cellulases, as harshness reducing agents. It is thought that cellulase achieves its anti-harshening effect on, e.g. cotton, by cleaving the cellulosic fibrils which form on the cotton fibres during the normal washing process.

This cleavage prevents the fibrils from bonding together and thereby introducing a degree of rigidity into the fabric.

It is preferred to use cellulases which have an optimum activity at alkaline pH values, such as those described in British Patent Specifications GB 2 075 028 A (Novo Industries A/S), GB 2 095 275 A (Kao Soap Cc Ltd) and 2 094 826 A (Kao Soap Co ltd).

Examples of such alkaline cellulases are cellulases produced by a strain of Humicola insolens (Humicola grisea var. thermoidea) particularly the Humicola strain DSM 1800, cellulases produced by a fungus of Bacillus N or a cellulase 212-producing fungus belonging to the genus Aeromonas, and cellulase extracted from the hepatopancreas of a marine mollusc (Dolabella Auricula Solander).

The amount of cellulase in a tablet of the invention will, in general, be from 0.1 to 10% by weight. In terms of cellulase activity the use of cellulase in an amount corresponding to from 0.25 to 150 or higher regular CX units/gram of the composite washing product.

c) Clays

Certain clays with ion exchange properties are effective as fabric softeners. It is believed that clay materials achieve their softening benefit, on e.g. cotton, by coating the cotton fibrils with a layer of lubricating material. This coating lowers the friction between the fibrils and reduced their tendency to bond together.

Suitable clay materials are phyllosilicate clays with a 2:1 layer structure, which definition includes smectite clays such a pyrophyllite, nontmorillonite, hectorite, saponite and vermiculite, and includes micas. Particularly suitable clay materials are the smectite clays described in U.S. Pat. No. 4,062,647 (Storm et al assigned to the Procter & Gamble Company). Other disclosures of suitable clay materials for fabric softening purposes include European patent specification EP 26528-a (Procter & Gamble Limited). U.S. Pat. No. 3 959 155 (Montgomery et al assigned to The Procter & Gamble Company) and U.S. Pat. No. 3 936 537).

EP 177 165 discloses that clays can be used in combination with cellulase. Also suitable for use in the tablets of the present invention are the combinations of clays and tertiary amines which are disclosed in EP 011340 (The Procter & Gamble Company).

Particularly preferred clays have an ion exchange capacity of at least 50 meq/100 g of clay. The ion exchange capacity relates to the expandable properties of the clay and to the charge of the clay, and is conventionally measured by electrodialysis or by exchange with ammonium ion followed by titration.

d) Polysiloxanes and their Derivatives

Silicone oils (polysiloxanes) have been proposed as fabric conditioning agents, and more specifically polysiloxanes with amino alkyl side chains have been proposed. Discussions of these materials can be found in GB-A-1549180 where they are included in fabric softener formulations to assist ironing of the fabric and to inhibit wrinkling.

EP-A-150867 discloses the incorporation of amino alkyl polysiloxanes into particulate detergent compositions to enhance the softeners and handling of washed fabrics. Their use in particulate compositions is also disclosed in FR-A-2713237 which utilises them as fabric softeners.

These materials may be mixed into nonionic detergent before that is incorporated into a particulate composition, as taught by EP-A-150867, or absorbed directly into a particulate carrier, as taught by FR-A-271237, and mixed with the remainder of a particulate composition. The particulate composition can thereafter be compacted to form a zone of a tablet in accordance with the present invention.

The amino alkyl polysiloxanes function as fibre lubricants. They are desirably incorporated into the more rapidly disintegrating first zone)s) of a tablet of this invention, so as to deposit on fabric at an early stage of the washing cycle.

Another fabric conditioning agent which may be utilised is a curable amine functional silicone (amino alkyl polysiloxane) disclosed in U.S. Pat. No. 4,911,852 (Procter Gamble) as an anti-wrinkle agent.

Encapsulation

The rinse additive is encapsulated by the preferred terpolymers as described above. Generally any suitable form of encapsulation can be used.

In a first preferred embodiment the rinse additive is embedded in a matrix of the terpolymer. Preferably the weight ratio of terpolymer to rinse additive is from 0.01:1 to 1:1.

In a second preferred embodiment the rinse additive is in the form of particles e.g. having a size of more than 1 mm, e.g. up to 8 cm and wherein the polymer is present as a coating surrounding the particles. Preferably the layer thickness of such a coating is more than 25 micron preferably more than 75 micron, more preferred from 200 to 500 micron.

In a third preferred embodiment the terpolymer is formed into films which can be formed into sachets or capsules containing the rinse additive e.g. in liquid or powdered form. Preferably the thickness of the film is more than 25 micron, preferred more than 75 micron, more preferred from 200 to 500 micron.

Cleaning Compositions

Wash compositions contain one or more components useful for the washing of textile fabrics, for example, surfactants, detergency builders, bleaches, enzymes and other minor ingredients. Suitable ingredients for cleaning compositions of the invention include:

a) Surfactants

Cleaning compositions for use according to the invention comprises one or more anionic surfactants and one or more nonionic surfactants.

Many suitable surface-active compounds are available and are fully described in the literature, for example, in “Surface-Active Agents and Detergents”, Volumes I and II, by Schwartz, Perry and Berch.

The total level of all surfactant(s) in the cleaning composition as a whole may for example be from 0.1% to 70% by weight the total composition but is preferably from 5% to 40%.

Preferably the weight ratio of anionic to nonionic is from 10:1 to 1:10, more preferred from 8:1 to 1:2 most preferred from 5:1 to 1:1.

a.1 Anionic Surfactants

Most preferred are the linear alkylbenzene sulphonate anionic surfactants having an average alkyl component of C₈-C₁₅.

Yet other suitable branched anionic surfactants include secondary alkylsulphonates, secondary alcohol sulphates and secondary alkyl carboxylates.

Suitable further anionic surfactants are well-known to those skilled in the art. These include primary alkyl sulphates, particularly C₈-C₁₅ primary alkyl sulphates; alkyl ether sulphates; olefin sulphonates; alkyl xylene sulphonates; dialkyl sulphosuccinates; and fatty acid ester sulphonates. Sodium salts are generally preferred.

a.2 Nonionic Surfactants

Cleaning compositions preferably also contain nonionic surfactant. Nonionic surfactants that may be used include fatty acid methyl ester ethoxylates (FAMEE's), e.g. as supplied by Lion Corp., Henkel KGA, Condea or Clairant, the primary and secondary alcohol ethoxylates, especially the C₈-C₂₀ aliphatic alcohols ethoxylated with an average of from 1 to 20 moles of ethylene oxide per mole of alcohol, and more especially the C₁₀-C₁₅ primary and secondary aliphatic alcohols ethoxylated with an average of from 1 to 10 moles of ethylene oxide per mole of alcohol. Non-ethoxylated nonionic surfactants include alkylpolyglycosides, glycerol monoethers, and polyhydroxyamides (glucamide).

(b) Detergency Builders

Laundry cleaning compositions, will generally also contain one or more detergency builders. The total amount of detergency builder in the compositions will typically range from 5 to 80 wt %, preferably from 10 to 60 wt % by weight of the cleaning composition.

Inorganic builders that may be present include sodium carbonate, if desired in combination with a crystallisation seed for calcium carbonate, as disclosed in GB-A-1 437 950; crystalline and amorphous aluminosilicates, for example, zeolites as disclosed in GB-A-1 473 201, amorphous aluminosilicates as disclosed in GB-A-1 473 202 and mixed crystalline/amorphous aluminosilicates as disclosed in GB-A-1 470 250; and layered silicates as disclosed in EP-A-164 514. Inorganic phosphate builders, for example, sodium orthophosphate, pyrophosphate and tripolyphosphate are also suitable for use with this invention.

The cleaning compositions of the invention preferably contain an alkali metal, preferably sodium, aluminosilicate builder. The alkali metal aluminosilicate may be either crystalline or amorphous or mixtures thereof, having the general formula: 0.8-1.5 Na₂O. Al₂O₃. 0.8-6 SiO₂.

Organic builders that may be present include polycarboxylate polymers such as polyacrylates, acrylic/maleic copolymers, and acrylic phosphinates; monomeric polycarboxylates such as citrates, gluconates, oxydisuccinates, glycerol mono-, di- and trisuccinates, carboxymethyloxy succinates, carboxy methyloxymalonates, dipicolinates, hydroxyethyliminodiacetates, alkyl- and alkenylmalonates and succinates; and sulphonated fatty acid salts. This list is not intended to be exhaustive.

(c) Bleaches

Cleaning compositions may also suitably contain a bleach system. Fabric washing compositions may desirably contain peroxy bleach compounds, for example, inorganic persalts or organic peroxyacids, capable of yielding hydrogen peroxide in aqueous solution.

Suitable peroxy bleach compounds include organic peroxides such as urea peroxide, and inorganic persalts such as the alkali metal perborates, percarbonates, perphosphates, persilicates and persulphates. Preferred inorganic persalts are sodium perborate monohydrate and tetrahydrate, and sodium percarbonate.

Especially preferred is sodium percarbonate having a protective coating against destabilisation by moisture. Sodium percarbonate having a protective coating comprising sodium metaborate and sodium silicate is disclosed in GB-A-2 123 044.

The peroxy bleach compound is suitably present in an amount of from 0.1 to 35 wt %, preferably from 0.5 to 25 wt %. The peroxy bleach compound may be used in conjunction with a bleach activator (bleach precursor) to improve bleaching action at low wash temperatures. The bleach precursor is suitably present in an amount of from 0.1 to 8 wt %, preferably from 0.5 to 5 wt %.

(d) Enzymes

Cleaning compositions according to the invention may also contain one or more enzyme(s). Suitable enzymes include the proteases, amylases, cellulases, oxidases, peroxidases and lipases usable for incorporation in detergent compositions. Preferred proteolytic enzymes (proteases) are, catalytically active protein materials which degrade or alter protein types of stains when present as in fabric stains in a hydrolysis reaction. They may be of any suitable origin, such as vegetable, animal, bacterial or yeast origin.

(e) Other Optional Minor Ingredients

Cleaning compositions may contain alkali metal, preferably sodium carbonate, in order to increase detergency and ease processing. Sodium carbonate may suitably be present in amounts ranging from 1 to 60 wt %, preferably from 2 to 40 wt %. However, compositions containing little or no sodium carbonate are also within the scope of the invention.

Yet other materials that may be present in detergent compositions of the invention include sodium silicate; antiredeposition agents such as cellulosic polymers; inorganic salts such as sodium sulphate; lather control agents or lather boosters as appropriate; dyes; coloured speckles; perfumes; foam controllers; fluorescers and decoupling polymers. This list is not intended to be exhaustive.

In use the composite wash product of the invention will be dosed to the washing machine prior to the start of the washing process. Suitably the composite washing product may be dosed in the drawer or the drum of a washing machine. Suitably the composite washing product may be used in combination with a dispenser such as a net or a shuttle.

The invention will now be illustrated by means of the following examples.

### EXAMPLE I

### Example 1

### Polymer Matrix in Tablet

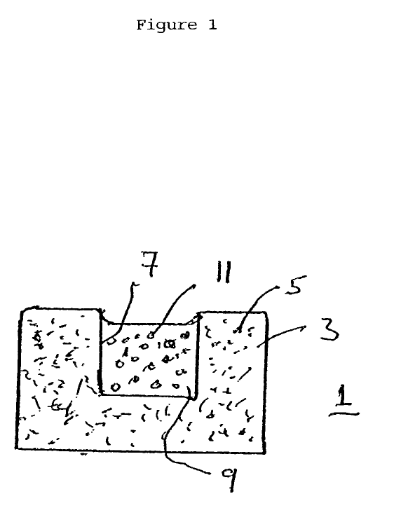

FIG. 1 shows a unit dose unit 1 for use according to the present invention. It comprises a tablet 3 of a granular detergent cleaning composition 5, having a composition in the range of formulation A (parts by weight):

| | Parts by weight |
|---|---|
| NaLAS | 9.3 |
| Nonionic 7EO | 2.6 |
| Nonionic 3EO | 1.4 |
| Soap | 0.7 |
| Zeolite A24 (anhydrous) | 20.8 |
| Sodium acetate | 27.4 |
| Soda ash | 3.1 |
| SCMC | 0.4 |
| Minors etc. | 4.00 |
| Antifoam | 2.5 |
| Fluorescer (15% ac.) | 1.2 |
| Soil release polymer | 0.1 |
| Na-di-silicate (granular) | 2.5 |
| TAED | 5.0 |
| Percarbonate (coated) | 15 |
| Sequestrant | 1.3 |
| Proteolytic and Lypolytic | 0.8 |
| enzymes | |
| Perfume | 0.4 |

Na LAS—Sodium Docecyl Benzene Sulphonate

Nonionic 7EO or 3EO—C₉-C₁₁ alkohol ethoxylated with an average of seven or three ethylene oxide units respectively

SCMC—Sodium Carboxy Methyl Cellulose

The tablet is formed by compression of the granular ingredient 5 but in a die such as to be formed with a central cavity 7.

The central cavity 7 is formed with Polymer 1 which is a polyacrylate-terpolymer, synthesized from a blend of the following weight composition 23% MMA (methylmethylacrylate) 45% DMAEMA (N,N-dimethylamino ethyl methacrylate) and 32% DMAPMA (dimethylaminopropylmethacrylic acid amine)

A granular fabric softening composition 11 (Formation B) is, together with a dissolution aid like Na-acetate or Na-citrate, dispersed in the polymer composition 9 such that it becomes encapsulated therein. The fabric softener is mixed with the polymer and poured into the cavity 7, whereupon it sets to form a solid matrix of the composition 11 and solidified polymer 9.

The granular fabric softening composition 11 has the following formulation B:

| Material | Parts by weight |
|---|---|
| HEQ | 34.5 |
| Urea | 41.48 |
| Dobanol 91/6 | 6.14 |
| Water | 5.77 |
| Perfume | 2.88 |
| PEG | 1.95 |
| Dye | 0.28 |
| Microsil GP | 7.00 |

HEQ is a hardened tallowyl fatty acid quaternary fabric softener, ex Clairant

Dobanol 91/6 is a C₉₋₁₁ average 6EO nonionic surfactant ex Shell

PEG 1500 is polyethylene glycol MW=1500.

Microsil GP is a commercially available silica based flow aid.

Polymer 1 is such that it is substantially insoluble at the pH and ionic strength of the wash liquor (the granular wash composition 5 dissolves quite rapidly, at least sufficiently to achieve these conditions). However, the Polymer 1 is readily soluble at the pH and ionic strength of the rinse liquor).

A variant of this example, wherein the polymer is in the form of a melt, is described hereinbelow in Example 2.

### Example 2

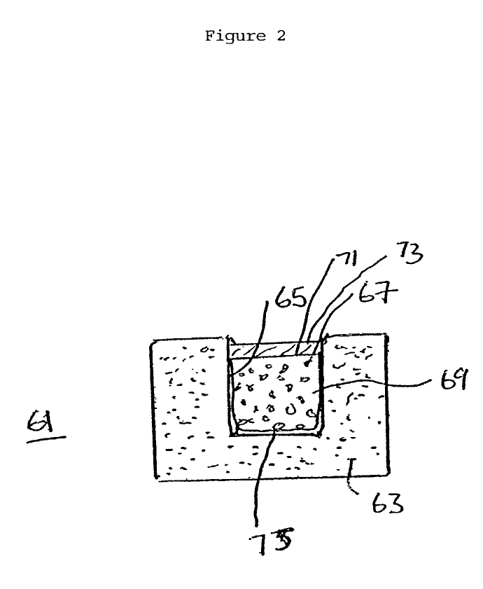

FIG. 2 shows another tablet embodiment 61. The tablet comprises a granular wash composition 63 identical to the composition of detergent wash composition 5 in FIG. 1 (i.e. having Formulation A). As with the embodiment of FIG. 1, the tablet also includes a central cavity 65.

A granular fabric softening composition 67, identical to that having Formulation B recited above, is located in the cavity 67, dispersed in a water-soluble polyethylene glycol (PEG). The composition is mixed with the polymer melt before pouring into the cavity 67, by making use of the shear thinning behaviour of the gel or by using a cooling tunnel.

The upper surface 71 of the set gel matrix 69, including the softening composition 67, is covered with a polymer film 73 which extends in contiguous fashion to line the inside of the cavity 65 in the form of a lining 75. The polymer used in to form the lining 75 and film 73 is identical to that of Polymer 1 recited above.

In use, the tablet of FIG. 2 dissolves in the wash liquor but the pH of the wash liquor is such that the “capsule” formed by the polymer film 73 and lining 75 does not dissolve. It survives until the rinse cycle, when the lower pH allows it to dissolve and the contents released. At that point, the gel 69 dissolves or disperses, releasing the rinse composition 67 into the rinse liquor.

It will be appreciated that the “capsule” of polymer is fragile. Therefore, it is especially advantageous in this embodiment for the tablet as a whole to be dosed by means of a net.

### Example 3

### Rinse Conditioner Capsule

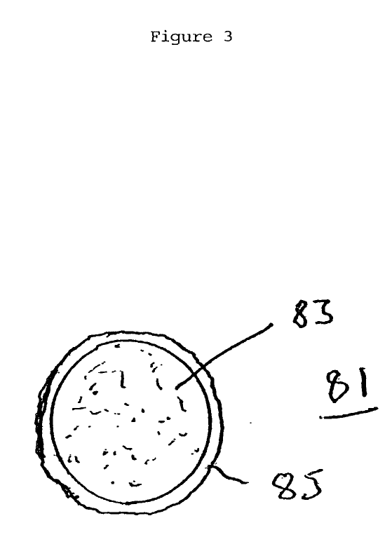

FIG. 3 shows a capsule 81 according to a fourth embodiment of the present invention.

A granule of 1.5 cm diameter is formed by granulating the composition of Formula B (fabric softening composition) with a dissolution aid such as sodium citrate or sodium acetate in a fluid bed granulator, operated such that large agglomerates can form. This produces a nearly-spherical granule 83. This granule is then dipped-coated in a melt of Polymer 1 as recited above. In this way, the granule 83 is coated with a polymer film 85. Dosed in a net together with washing composition A—compressed into a tablet—into the wash liquor, it remains intact until the rinse cycle, whereupon, the lower pH allows the polymer to dissolve and the granular rinse conditioner to be dispersed into the rinse liquorThe filling of the core 83 of capsule 85 in FIG. 5 may also be a non-aqueous liquid rinse composition.

### Examples 4A-4D

### Multi-Layer Tablets

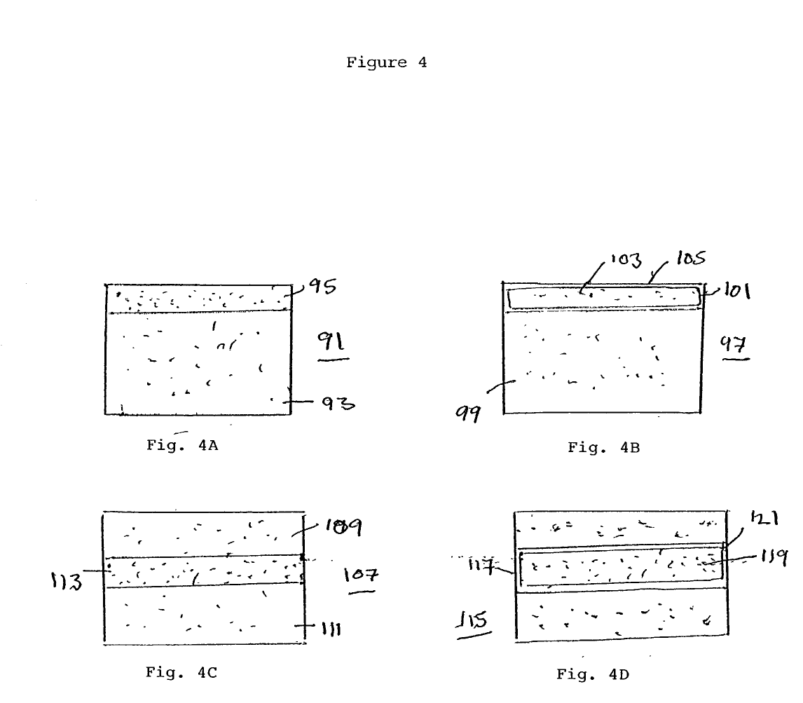

Turning now to FIG. 4A, there is shown a tablet form 91 according to the present invention. It comprises a (larger) lower portion 93 comprising a tableted wash composition corresponding to composition 5 in the embodiment of FIG. 1. The upper layer 95 comprises the same rinse composition 11 of the embodiment of FIG. 1, in a delayed release matrix as before. The manufacture of bi-layer tablets is well known in the art.

In FIG. 4B, a bi-layer tablet 97 has a lower layer 99 corresponding to the lower layer 93 of the embodiment of FIG. 6A. However, the upper layer 101 comprises a rinse composition 103 corresponding to composition 67 in the embodiment of FIG. 4, encapsulated in a delayed release polymer shell 105 corresponding to shell 75 in the embodiment of FIG. 4.

FIG. 4C shows a variant of the embodiment of FIG. 6A but as a tri-layer tablet. This designated 107. The upper 109 and lower 111 layers correspond to the tableted wash composition 93 in the embodiment of FIG. 6A. The middle layer 113 has the same rinse composition embedded in a delayed release matrix as the layer 95 in the embodiment of FIG. 6A.

In the embodiment of FIG. 4D, the trilayer tablet is analogous to the embodiment of FIG. 6B and is denoted by numeral 115. A central layer 117 has the same rinse composition as composition 103 in the embodiment of FIG. 4B and is denoted by numeral 119. It is surrounded by a delayed release polymer shell 121 of the same composition as that of shell 105 in FIG. 4B.

Thus in general, the softener composition may be co-granulated in a delayed release polymer melt as referred to in hereinbefore or coated with a polymer in a bi or tri layer tablet form.

### Example V

A number of terpolymers were synthesized with the following compositions as indicated in table 1A.

The polymers were tested as follows: A first wash solution was prepared comprising 670 ppm of a mixture of 70% LAS, 20% nonionic 7EO and 10% nonionic 3EO (high pH conditions) and a second wash solution comprising 70 ppm. Of said mixture. Both wash solutions were kept at 20 degrees celsius.

The terpolymers were incorporated into a solution of 50 wt % ethanol and 50% terpolymer containing a suitable plasticizer and then cast into films of 100-400 micron thickness.

The films were used to prepare sachets of size 30×30 mm, each sachet comprising a tablet of clay of type QPC200G and weight of 1.5 to 8.0 gms.

In a first test a sachet with the clay tablet was immersed into the high pH wash solution and the percentage weight loss after 20 minutes was measured. Similarly a sachet with the clay tablet was immersed in the low pH solution and again the percentage weight loss after 20 minutes was measured. For each polymer the ratio of weight loss in the low pH solution to the weight loss in the high pH solution was calculated.

The following results were obtained illustrating that terpolymers in accordance to the invention provide improved properties as compared to other terpolymers.

TABLE 1A

| | | Wt % | Wt % | Ratio of |
|---|---|---|---|---|
| | Wt % MMA | DMAEMA | DMAPMA | weight loss |
| Polymer | B | A | C | low pH/high pH |
| A | 20 | 30 | 50 | 1.40 |
| B | 30 | 30 | 40 | 1.73 |
| C | 30 | 45 | 25 | 1.05 |
| D | 20 | 40 | 40 | 1.32 |
| E | 23 | 45 | 32 | 1.81 |
| F | 25 | 38 | 37 | 1.21 |
| G | 30 | 35 | 35 | 1.09 |
| H(control) | 25 | 75 | 0 | 0.67 |
| I | 15 | 75 | 10 | 1.34 |
| J | 10 | 70 | 20 | 1.41 |
| K | 10 | 80 | 10 | 1.22 |
| L | 40 | 10 | 50 | 2.42 |
| M | 30 | 10 | 60 | 1.26 |
| N | 50 | 10 | 40 | 1.89 |

The above results show that the ratio of greater than unity means the triggered release action is present and the ratio higher than one indicates its improved effectiveness as pH triggered properties.

In the light of the described embodiments and examples, variations of those embodiments and examples, as well as other embodiments and examples, all within the spirit and scope of the present invention, for example as defined by the appended claims, will now become apparent to persons skilled in this art.

1. A method of washing and rinsing a textile fabric, the method comprising:
(a) a washing step wherein the washing liquor comprises an anionic surfactant, a nonionic surfactant and a rinse additive encapsulated in a terpolymer;and
(b) subsequent to the washing step (a), a rinse step;
wherein the terpolymer comprises monomers A, B and C, wherein:
A is a monomer represented by the fomula
CH₂═C(R³)—COOCH₂CH₂N(R¹)R²
Wherein R¹ and R²each are independantly chosen from alkyl groups having 1, 2 or 3 carbon atoms; and wherein R³ is a hydrogen or a methyl group; and
Wherein B is selected from the group of esters of a C1-3 alcohol with a member of the group of acrylic acid, methacrylic acid, crotonic acid, itaconic acid and vinyl acetate;
C is selected from the group of N,N dimethylaminopropyl(meth) acrylic acid amide, N,N dimethyl(meth)acrylic acid amide, 2-hydroxyethyl(meth)acrylate, 2-hydroxypropyl(meth)acrylate) or esters of (meth) acrylic acid and polyetheylene glycol or methoxypolyethylene glycol (p=2-50); and
Wherein A is present in amounts of 5-95 wt % of the terpolymer; B is present in amounts of less than 66 wt % of the terpolymer and C is present in levels of at least 1 wt % of the terpolymer; and wherein the level of B (B) in relation to the level of A (A) satisfies the following conditions:
(5) 0<B<66%−0.5*A
(6) 30%−0.5*A<B<66%.

2. A composite washing product comprising
(I) a cleaning composition comprising an anionic and a nonionic surfactant; and
(II) a rinse additive encapsulated in a terpolymer;
wherein the terpolymer comprises monomers A, B and C, wherein:
A is a monomer represented by the fomula
CH₂═C(R³)—COOCH₂CH₂N (R¹) R²
Wherein R¹ and R²each are independantly chosen from alkyl groups having 1, 2 or 3 carbon atoms; and wherein R³ is a hydrogen or a methyl group; and
Wherein B is selected from the group of esters of a C1-3 alcohol with a member of the group of acrylic acid, methacrylic acid, crotonic acid, itaconic acid and vinyl acetate;
C is selected from the group of N,N dimethylaminopropyl(meth) acrylic acid amide, N,N dimethyl(meth)acrylic acid amide, 2-hydroxyethyl(meth)acrylate, 2-hydroxypropyl(meth)acrylate) or esters of (meth) acrylic acid and polyetheylene glycol or methoxypolyethylene glycol (p=2-50); and
Wherein A is present in amounts of 5-95 wt % of the terpolymer; B is present in amounts of less than 66 wt % of the terpolymer and C is present in levels of at least 1 wt % of the terpolymer; and wherein the level of B (B) in relation to the level of A (A) satisfies the following conditions:
(7) 0<B<66%−0.5*A
(8) 30%−0.5*A<B<66%.
Wherein k is 0.5

3. Composite wash product according to claim 2 wherein the level of B is from 5-40 wt % or from 80-94 wt %.

4. Composite wash product according to claim 2 wherein A is N, N-dimethylaminoethylmethacrylate, B is dimethylaminopropylmethacrylic acid amine and C is methyl methacrylate.

5. A composite wash product according to claim 2, being a tablet comprising at least one region formed by a cleaning composition and at least one region formed by an encapsulated rinse additive.

6. A composite wash product according to claim 2 wherein the encapsulation of the rinse additive is selected from embedding the rinse additive in a matrix of the terpolymer, coating the rinse additive with the terpolymer or forming a sachet or capsule of the terpolymer, said sachet or capsule containing the rinse additive.

7. A composite wash product according to claim 5, wherein the thickness of the terpolymer encapsulate is from 100-500 micron.
